(19) United States
(12) Patent Application Publication
(10) Pub. No.: US 2008/0284414 A1
(43) Pub. Date: Nov. 20, 2008

(54) Hysteresis Brake, Especially for an Electric Camshaft Adjuster

(75) Inventors: Lorenzo Giovanardi, Firenze (IT); Matthias Gregor, Stuttgart (DE); Jens Meintschel, Esslingen (DE); Bernd-Heinrich Schmitfranz, Esslingen (DE); Guenter Stoehr, Siegen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/596,333

(22) PCT Filed: Apr. 28, 2005
(86) PCT No.: PCT/EP05/04530

§ 371 Date: Aug. 14, 2007

(30) Foreign Application Priority Data
May 12, 2004 (DE) 10 2004 023 392.6

(51) Int. Cl. G01B 7/30

(52) U.S. Cl. 324/207.2; 324/207.25

(57) ABSTRACT

A hysteresis brake is provided, such as for an electric camshaft adjuster, has with an excitation coil, a stator with an inner and outer stator part, and a moveable rotor with a hysteresis band which is movable between the inner and outer stator part. The excitation coil, which produces a main magnetic flux for a magnetic adjuster is arranged between the inner and outer stator part. A sensor enables the rotor and/or the hysteresis band to receive a secondary magnetic flux caused by the main magnetic flux, or enables the excitation coil to receive the main flux. An evaluation and control unit evaluates the magnetic flux received and determines angle and/or rotational speed information from detected changes of the magnetic flux.

### CROSS REFERENCE TO RELATED APPLICATIONS

This application is a national stage of PCT International Application No. PCT/EP2005/004530, filed Apr. 28, 2005, which claims priority under 35 U.S.C. § 119 to German Patent Application No. 10 2004 023 392.6, filed May 12, 2004, the entire disclosures of which are herein expressly incorporated by reference.

### BACKGROUND AND SUMMARY OF THE INVENTION

The present invention relates to a hysteresis brake, especially for an electric camshaft adjuster.

Passive, (drive-free) electric camshaft adjusters which can change the phase position of a camshaft are known from the prior art. An electric camshaft adjuster of this type is described, for example, in German patent document DE 102 47 650 A1 and includes a brake and a lever mechanism. An alternative embodiment of the electric camshaft adjuster with a brake and a summing gear mechanism is described in German patent document DE 103 55 560.

For the electric camshaft adjusters, hysteresis brakes can be used which operate contactlessly and in a manner free from wear. In order to adjust the phase position of the camshaft, knowledge of the angular position of a rotor of the hysteresis brake is required.

In order to measure the angular position of the camshaft or of the hysteresis brake, angle of rotation sensors which are known from the prior art may be used, such as are described, for example, in German patent documents DE 195 31 621 A1 and DE 100 34 927 A1. These angle of rotation sensors require a transmitter element rotating together with a rotor and a fixed sensor unit for producing a measuring signal from which angle and/or rotational speed information is determined. The measurement principle may be optical or magnetic.

It is an object of the present invention to provide a hysteresis brake, especially for an electric camshaft adjuster, which permits simple determination of angle and/or rotational speed information items.

This and other objects and advantages are achieved by the hysteresis brake according to the present invention, a first embodiment of which includes a sensor for enabling a moveable rotor and/or a hysteresis band to receive a secondary magnetic flux caused by a main magnetic flux. An evaluation and control unit evaluates the secondary magnetic flux received and determines angular and/or rotational speed information for a camshaft from detected changes of the secondary magnetic flux.

Alternatively, a second embodiment of the hysteresis brake according to the invention includes a sensor for enabling an excitation coil to receive a main magnetic flux, and an evaluation and control unit which evaluates the main magnetic flux received, detects changes in the main flux and determines angle and/or rotational speed information from the detected changes. The changes in the main flux are caused by changes of the magnetic resistance that are caused by a rotor and/or a hysteresis band. In this alternative embodiment, instead of the changes of the secondary flux, the changes in the main magnetic flux are evaluated to determine the angle and/or rotational speed information.

The embodiments of the hysteresis brake according to the present invention have the advantage that, by using the secondary magnetic flux or the main magnetic flux to determine the angle and rotational speed information, a sensor can be constructed in a simple manner, since separate transmitter elements are not required. The use of components which are required in any case for the function of the hysteresis brake for the angle and/or rotational speed determination makes it possible to reduce the cost for fixing, cabling and contact connection. The components used merely have to be adapted in their configuration to the additional task.

To determine the angle and/or rotational speed, the rotor and/or the hysteresis band of the hysteresis brake may be geometrically designed in such a manner that the magnetic flux through the sensor changes cyclically as the rotor and/or hysteresis band rotates.

In a refinement of the hysteresis brake, the rotor may include a ferromagnetic ring which has a rectangular toothed profile with at least one elevation and/or cut-out and/or one or more apertures.

Additionally or alternatively, the hysteresis band may have at least one rectangular and/or round apertures and/or one or more regions with thinner and/or thicker walls.

The toothed profile and/or the apertures and/or the regions with thinner and/or thicker walls give rise to different values for the magnetic resistance and therefore for the secondary or main magnetic flux detected. This is the case, because with a high magnetic resistance alternate cyclically with regions with a low magnetic resistance. These cyclic changes of the magnetic flux can be detected by a simple sensor and can be evaluated by the evaluation and control unit. The required refinement of the rotor or hysteresis band can be undertaken in a simple manner during production of the components.

In a refinement of the first embodiment of the hysteresis brake, the sensor for receiving the secondary magnetic flux may be integrated in the stator, e.g., in the outer stator part.

The sensor may include at least one sensor coil with a ferromagnetic core, and/or at least one Hall sensor which receive the secondary magnetic flux and pass it on in the form of a voltage signal to the evaluation and control unit.

In a further refinement, the sensor for determining the direction of rotation may include a second sensor coil with a ferromagnetic core, and/or a second Hall sensor which produce a further voltage signal which may be phase-displaced by 90° in relation to the other voltage signal.

The first and second sensor coils produce, for example, voltage signals with different amplitudes which can be transmitted to the evaluation and control unit on a common connecting line. Due to the different amplitudes, the signals can easily be differentiated in the evaluation and control unit, and, in spite of the second sensor coil, the number of lines and contact connections remains the same as in the embodiment with only one sensor coil.

In a refinement of the second embodiment, the sensor for receiving the main magnetic flux may be arranged in the region of the excitation coil.

The sensor for receiving the main magnetic flux may include, for example, at least one sensor coil and/or a Hall sensor.

In a further refinement, the excitation coil carries out the function of the sensor and receives the main magnetic flux which is passed on in the form of a voltage signal to the evaluation and control unit. As a result, the components for determining the angle and/or rotational speed information can be further reduced.

In a further refinement of the hysteresis brake, the evaluation and control unit allows for an operationally induced change of the main magnetic flux, for example when producing a different braking torque, during the determination of the angle and/or rotational speed information in the form of interference signals.

The hysteresis brake according to the present invention may be used, for example, in an electric camshaft adjuster.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 shows a diagrammatic block circuit diagram of a hysteresis brake according to the present invention,

FIG. 2 shows a diagrammatic three-dimensional illustration of a first exemplary embodiment of the hysteresis brake with a sensor for determining the magnetic flux,

FIG. 3 shows a diagrammatic three-dimensional detailed illustration of the hysteresis brake from FIG. 2,

FIG. 4 shows a diagrammatic three-dimensional detailed illustration of a hysteresis band of the hysteresis brake,

FIG. 5 shows a diagrammatic three-dimensional illustration of a second exemplary embodiment of the hysteresis brake with a sensor for determining the magnetic flux,

FIG. 6 shows a diagrammatic three-dimensional detailed illustration of the hysteresis brake from FIG. 5,

FIG. 7 shows a diagrammatic sectional illustration of a third exemplary embodiment of the hysteresis brake with a sensor for determining the magnetic flux,

FIG. 8 shows a diagrammatic three-dimensional detailed illustration of the hysteresis brake with a first exemplary embodiment of the hysteresis band,

FIG. 9 shows a diagrammatic three-dimensional detailed illustration of the hysteresis brake with a second exemplary embodiment of the hysteresis band, and

FIG. 10 shows a diagrammatic three-dimensional detailed illustration of the hysteresis brake with an exemplary embodiment of the moveable rotor.

### DETAILED DESCRIPTION OF THE DRAWINGS

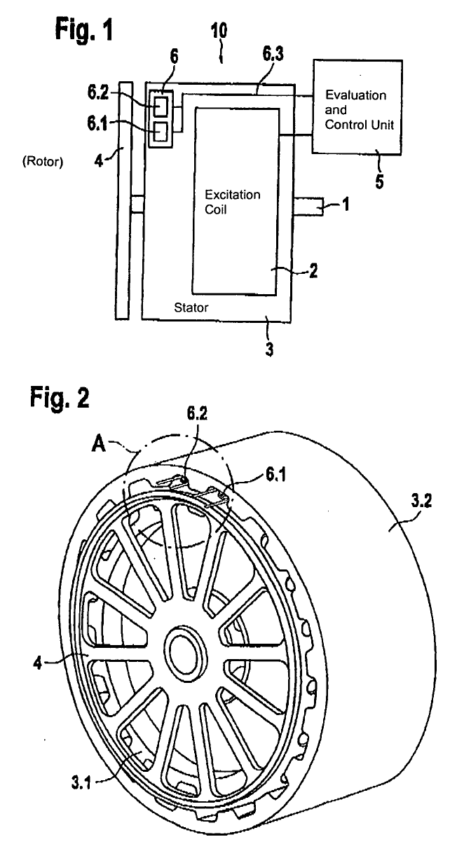

As is apparent from FIG. 1, a hysteresis brake for an electric camshaft adjuster may include a magnetic adjuster 10 for a camshaft 1, the magnetic adjuster having an excitation coil 2, a stator 3, a rotor 4 which is moveable with the camshaft, an evaluation and control unit 5 and a sensor for receiving a magnetic flux 6 which is evaluated by the evaluation and, control unit 5 in order to determine angle and/or rotational speed information items for the camshaft 1. These information items are required for adjusting the phase position of the hysteresis brake. In order to determine the angular position of the camshaft 1, the angular position of the rotor 4 of the hysteresis brake, which rotor is coupled to the camshaft 1, is determined. The components of the magnetic adjuster 10 or of the hysteresis brake are designed in such a manner that a change of the magnetic flux is brought about by the sensor 6 as the rotor 4 or a hysteresis band 4.1 connected to the rotor 4 rotates.

FIGS. 2 to 10 show exemplary embodiments in which the sensor is designed as at least one coil 6.1, 6.2, also referred to below as a sensor coil. The change of the magnetic flux can be measured in accordance with the law of induction at the sensor coils 6, 6.1, 6.2 as an electric voltage signal. This voltage signal is transmitted to the evaluation and control unit 5 and is processed there to provide angle and rotational speed information.

The functioning of the hysteresis brake according to the present invention is described below with reference to FIGS. 2 to 10.

FIGS. 2, 3 and 4 show a diagrammatic three-dimensional illustration of a first exemplary embodiment of the hysteresis brake, which includes an inner and outer stator part 3.1, 3.2, a rotor 4 with hysteresis band 4.1 and sensor 6 which is designed as sensor coils 6.1 and 6.2 and is intended for determining the magnetic flux 7.1.

FIG. 3 shows an illustration of the detail A from FIG. 2. As is apparent from FIG. 3, a small part of the main magnetic flux necessary for operating the hysteresis brake is conducted via the inner stator part 3.1, the hysteresis band 4.1 and via the outer stator part 3.2 through the sensor coil 6.1 in the form of a secondary magnetic flux 7.1. The sensor coil 6.1 is integrated in the outer stator part 3.2 and may have a ferromagnetic core to reinforce the secondary magnetic flux 7.1. The hysteresis band 4.1 is geometrically designed in such a manner that the secondary magnetic flux 7.1 through the sensor coil 6.1 changes cyclically as a function of the current angle as the rotor 4 rotates. Due to the law of induction, the change in the secondary magnetic flux leads to an electric voltage in the sensor coil 6.1. The temporal sequence of the voltage pulses is processed in the evaluation and control circuit 5 to provide angle and rotational speed information.

As is furthermore apparent from FIG. 3, the sensor coil 6.1 is arranged radially to the axis of rotation of the rotor 4. The distance of the sensor coil 6.1 from the axis of rotation can be selected in such a manner that the coil 6.1 is covered by the rotor 4 or, as illustrated in FIG. 2, is arranged outside the rotor. The inner and outer stator parts 3.1, 3.2 may have a serrated or tooth-shaped surface profile, with depressions of the outer stator part 3.2 lying opposite elevations in the inner stator part 3.1 and vice versa, and with the sensor in a depression of the outer stator part 3.2 being arranged opposite an elevation in the lower stator part 3.1.

As is apparent from FIG. 4, a surface of the hysteresis band 4.1 that runs below the sensor coil 6.1 may be provided with round or rectangular apertures 4.2. Instead of the apertures 4.2, regions with differing wall thickness may optionally also be used, also see FIG. 9.

During rotation of the hysteresis band 4.1, regions with and without an aperture 4.2 are located in an alternating manner between the sensor coil 6.1 and the opposite elevation of the inner stator part 3.1. The magnetic resistance and therefore the secondary magnetic flux 7.1 through the sensor coil 6.1 changes accordingly. If, for example, an aperture 4.2 is located between sensor coil 6.1 and inner stator part 3.1, then, on account of the poor conductivity of air, the magnetic resistance is high and the magnetic flux 7.1 is small. If a region of the hysteresis band 4.1 without an aperture is located between the sensor coil 6.1 and the inner stator part 3.1, then, on account of the better conductivity of the hysteresis material, the magnetic resistance is low and the magnetic flux 7.1 is large. The change of the magnetic flux 7.1 through the sensor coil 6.1 leads, in accordance with the law of induction, to the abovementioned voltage at the sensor coil 6.1.

An optional, second sensor coil 6.2 makes it possible to additionally produce a voltage signal which may be displaced by 90°. As a result, direction of rotation information items can be determined by the evaluation and control unit. In addition, the resolution of the sensor 6 is increased. The arrangement of the second sensor coil 6.2 corresponds to the arrangement of the first sensor coil 6.1 apart from the fact that the second sensor coil 6.2 is arranged in a different depression of the outer stator part 3.2.

The two sensor coils 6.1, 6.2 may have different numbers of turns, as a result of which the amplitudes of the voltages induced differ in accordance with the ratio of the number of turns. The voltage signals of the two sensor coils 6.1, 6.2 can be passed via the same lines to the evaluation and control unit 5, since the latter can differentiate the voltage signals on the basis of their different amplitudes. As a result, in spite of the second sensor coil, the number of lines and contact connections remains the same as in the embodiment with one sensor coil.

Instead of the sensor coil 6.1, 6.2, sensors which directly measure the magnetic flux, such as Hall sensors, may be used.

FIGS. 5 and 6 show a further possibility for configuring the components of the hysteresis brake for evaluating the secondary magnetic flux 7.1 (FIG. 6 shows a detail B from FIG. 5). As is apparent from FIGS. 5 and 6, the sensor coils 6.1, 6.2 are arranged outside the rotor 4 in such a manner that their longitudinal axes run parallel to the axis of rotation of the rotor. A ring 4.3 of ferromagnetic material is fixed to the rotor 4 and moves in front of the coil planes of the sensor coils 6.1, 6.2.

As is furthermore apparent from FIG. 5, in the region of the coil axes, the ring 4.3 has a toothed profile which can be of essentially rectangular design, for example. If the sensor coils 6.1, 6.2 are arranged within the rotor 4, then the toothed profile can be replaced by apertures in the rotor 4.

During rotation of the rotor 4, a tooth of the toothed profile 4.3 and a cut-out are located in an alternating manner in front of the sensor coils 6.1, 6.2. The magnetic resistance and therefore the magnetic flux 7.1 through the sensor coils 6.1, 6.2 change accordingly. If an aperture is located in front of the sensor coils 6.1, 6.2, then, on account of the poor conductivity of air, the magnetic resistance is high and the magnetic flux 7.1 is small. If a tooth is located in front of the sensor coils 6.1, 6.2, then, on account of the better conductivity of the ferromagnetic material of the ring 4.3, the magnetic resistance is low and the magnetic flux 7.1 is large.

The magnetic flux 7.1 through the sensor coils 6.1, 6.2 is guided in a secondary magnetic flux 7.1 from the inner stator part 3.1 by the ring 4.3 around the hysteresis band 4.1 and through the sensor coils 6.1, 6.2 to the outer stator part 3.2. The magnetic flux through the sensor coils 6.1, 6.2 is evaluated as in the first exemplary embodiment illustrated in FIGS. 2, 3 and 4.

FIG. 7 shows an alternative embodiment of the hysteresis brake, in which, in order to determine angle and/or rotational speed information items, the change of the main magnetic flux 7 through the excitation coil 2 is detected. The changes of the main flux 7 occur due to local changes of the secondary flux 7.1 in the region of the hysteresis band 4.1 or of the rotor 4.

As is apparent from FIG. 7, the sensor coil 6 is designed as an additional coil and, like the excitation coil 2, is arranged axially around the camshaft. The additional sensor coil 6 may optionally be omitted. The excitation coil 2 then acts simultaneously as a sensor coil, the voltage signals of which are evaluated by the evaluation and control unit 5.

In the embodiment according to FIG. 7, the rotor 4 and/or the hysteresis band 4.1 are geometrically designed as parts of the hysteresis brake in such a manner that the magnetic flux 7 through the stator 3 (and therefore also through the sensor coil 6) changes cyclically as a function of the current angle as the rotor 4 or hysteresis band 4.1 rotates. On account of the law of induction, the change of the magnetic flux 7 leads to an electric voltage signal in the sensor coil 6, which voltage signal is evaluated by the evaluation and control unit 5 which processes the temporal sequence of the voltage signals to provide angle and rotational speed information.

FIGS. 8 to 10 show various possibilities for configuring the hysteresis band 4.1 and the rotor 4, which bring about a change in the magnetic flux through the sensor 6.

As is apparent from FIG. 8, the hysteresis band 4.1, analogously to FIG. 4, may have round or rectangular apertures 4.2. As the hysteresis band 4.1 rotates, regions with and without an aperture 4.2 are located in an alternating manner between the inner and outer stator part 3.1, 3.2. The magnetic resistance of the magnetic circuit and therefore the magnetic flux 7 through the stator 3 and therefore through the sensor coil 6 change accordingly.

If, for example, an aperture is located between the inner and outer stator part 3.1, 3.2, then, on account of the poor conductivity of air, the magnetic resistance is high and the magnetic flux 7 is small. If a region which does not have apertures is located between the inner and outer stator part 3.1, 3.2, then, on account of the better conductivity of the hysteresis material, the magnetic resistance is low and the magnetic flux 7 is large.

The local change in the magnetic flux leads to a change in the main flux 7. In accordance with the law of induction, the change of the magnetic flux 7 through the sensor coil 6 leads to an induced voltage signal at the sensor coil 6, the temporal sequence of which is processed in the evaluation and control unit 5 to provide angle and rotational speed information.

FIG. 9 shows an alternative embodiment of the hysteresis band 4.1 which has regions with different magnetic resistances which are realized by regions with lesser and greater wall thickness 4.4, 4.5. As the hysteresis band 4.1 rotates, regions with lesser and greater wall thickness 4.4, 4.5 are located in an alternating manner between the inner and outer stator part 3.1, 3.2. The magnetic resistance of the magnetic circuit and therefore the magnetic flux 7 through the sensor coil 6 change accordingly, with the regions with lesser wall thickness 4.4 bringing about a higher magnetic resistance and regions with greater wall thickness 4.5 bringing about a lower magnetic resistance. The changes of the magnetic flux are evaluated analogously to the evaluation already described.

As is apparent from FIG. 8, the rotor 4 has a ring 4.3 of ferromagnetic material analogous to FIG. 6. In the region of the elevations of the outer stator 3.2, the ring 4.3 may have an essentially rectangular, toothed profile. If the toothed profile 4.3 is arranged in the region between the axis of rotation of the rotor and the hysteresis band 4.1, then the toothed profile 4.3 can be replaced by apertures in the rotor 4. A combination of a toothed profile on the ring and of apertures in the rotor is also possible.

As the rotor 4 rotates, an elevation of the ring 4.3 or a cut-out of the ring 4.3 is located in an alternating manner in front of the elevation of the outer stator part 3.2. The magnetic resistance and therefore the magnetic flux through the sensor coil 6 change accordingly.

If a cut-out is located in front of the elevation of the outer stator part 3.2, then, on account of the poor conductivity of air, the magnetic resistance is high and the magnetic flux 7.1 is small. If an elevation of the ring 4.3 is located in front of the elevation of the outer stator part 3.2, then, on account of the better conductivity of the ferromagnetic material, the magnetic resistance is low and the magnetic flux is large.

The secondary magnetic flux 7.1 is then guided in a secondary magnetic flux around the hysteresis band to the opposite stator part. The local change of flux leads, as has already been described, to a change of the main flux 7. The change of the magnetic flux is evaluated, as has already been described, by the evaluation and control unit 5.

The evaluation and control unit 5 allows for an operationally induced change of the main magnetic flux 7 in the hysteresis brake during the determination of the angle and/or rotational speed information items.

The main magnetic flux 7 is changed, for example, if a different braking torque has to be produced in the hysteresis brake. The changing of the main magnetic flux 7 induces an interference voltage signal in the sensor coils 6, 6.1, 6.2 which is superimposed on the measuring signal. Since this interfering influence of the evaluation and control unit 5 is known, the superimposed interference voltage signal can be allowed for in the evaluation of the voltage signal to determine the angle and/or rotational speed information.

Instead of the sensor coils 6, 6.1, 6.2 described, sensors which directly measure the magnetic flux 7, 7.1, such as Hall sensors, may be used.

The hysteresis brake according to the present invention uses the operationally induced main magnetic flux and/or a secondary magnetic flux derived therefrom, and a sensor to determine angle and rotational speed information items. Since separate transmitter elements are not required, the receiver can be constructed in a simple manner. In addition, the cost for fixing, cabling and contact connection can be reduced.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-14. (canceled)

15. A hysteresis brake for an electric camshaft adjuster, comprising:
a stator including an inner stator part and an outer stator part;
a moveable rotor including a hysteresis band which is movable between the inner and outer stator parts;
an excitation coil for producing a main magnetic flux for a magnetic adjuster arranged between the inner and outer stator parts;
a sensor for enabling one of the rotor and the hysteresis band to receive a secondary magnetic flux caused by the main magnetic flux; and
an evaluation and control unit configured to evaluate the secondary magnetic flux and determine angle or rotational speed information from detected changes of the secondary magnetic flux.

16. The hysteresis brake as claimed in claim 15, wherein the sensor is integrated in the outer stator part of the stator.

17. The hysteresis brake as claimed in claim 15, wherein the sensor comprises one of a first sensor coil with a ferromagnetic core and a first Hall sensor which receives the secondary magnetic flux and outputs a first voltage signal to the evaluation and control unit based on the secondary magnetic flux.

18. The hysteresis brake as claimed in claim 17, wherein the sensor further comprises a second sensor coil with a ferromagnetic core or a second Hall sensor, which produces a second voltage signal which is phase-displaced by 90° in relation to the first voltage signal for determining the direction of rotation.

19. The hysteresis brake as claimed in claim 17, wherein the first and second sensor coils produce voltage signals with different amplitudes which can be transmitted to the evaluation and control unit on a common connecting line.

20. A hysteresis brake for an electric camshaft adjuster, comprising:
a stator including an inner stator part and an outer stator part;
a moveable rotor including a hysteresis band which is moveable between the inner and outer stator parts;
an excitation coil for producing a main magnetic flux for a magnetic adjuster arranged between the inner and outer stator parts;
a sensor for enabling the excitation coil to receive the main magnetic flux; and
an evaluation and control unit configured to evaluate the main magnetic flux, detect changes in the main magnetic flux and determine angle or rotational speed information from the detected changes in the main magnetic flux;
wherein the changes in the main magnetic flux are caused by changes in a magnetic resistance that are caused by one of the rotor and the hysteresis band.

21. The hysteresis brake as claimed in claim 20, wherein the sensor is arranged in the region of the excitation coil.

22. The hysteresis brake as claimed in claim 21, wherein the sensor comprises at least one sensor coil or at least one Hall sensor.

23. The hysteresis brake as claimed in claim 15, wherein the rotor or the hysteresis band is geometrically designed in such a manner that the magnetic flux through the sensor changes cyclically as a function of the current angle of rotation as the rotor rotates.

24. The hysteresis brake as claimed in claim 23, wherein the rotor comprises a ferromagnetic ring which has a rectangular, toothed profile or one or more apertures.

25. The hysteresis brake as claimed in claim 23, wherein the hysteresis band has at least one aperture or at least one region with thinner or thicker wall thickness.

26. The hysteresis brake as claimed in claim 20, wherein the excitation coil carries out the function of the sensor, receives the main magnetic flux and outputs a voltage signal to the evaluation and control unit based on the main magnetic flux.

27. The hysteresis brake as claimed in claim 15, wherein the evaluation and control unit allows for an operationally induced change of the main magnetic flux during the determination of the angle or rotational speed information in the form of interference signals.

28. The hysteresis brake as claimed in claim 16, wherein the sensor comprises one of a first sensor coil with a ferromagnetic core, and a first Hall sensor which receives the secondary magnetic flux and outputs a first voltage signal to the evaluation and control unit based on the secondary magnetic flux.

29. The hysteresis brake as claimed in claim 18, wherein the first and second sensor coils produce voltage signals with different amplitudes which can be transmitted to the evaluation and control unit on a common connecting line.

30. The hysteresis brake as claimed in claim 16, wherein the rotor or the hysteresis band is geometrically designed in such a manner that the magnetic flux through the sensor changes cyclically as a function of the current angle of rotation as the rotor rotates.

31. The hysteresis brake as claimed in claim 24, wherein the hysteresis band has at least one aperture or at least one region with thinner or thicker wall thickness.

32. The hysteresis brake as claimed in claim 21, wherein the excitation coil carries out the function of the sensor, receives the main magnetic flux and outputs a voltage signal to the evaluation and control unit based on the main magnetic flux.

33. The hysteresis brake as claimed in claim 20, wherein the evaluation and control unit allows for an operationally induced change of the main magnetic flux during the determination of the angle or rotational speed information in the form of interference signals.

34. An electric camshaft adjuster having a hysteresis brake for an electric camshaft adjuster, said brake comprising:
a stator including an inner stator part and an outer stator part;
a moveable rotor including a hysteresis band which is movable between the inner and outer stator parts;
an excitation coil for producing a main magnetic flux for a magnetic adjuster arranged between the inner and outer stator parts;
a sensor for enabling the rotor or the hysteresis band to receive a secondary magnetic flux caused by the main magnetic flux; and
an evaluation and control unit configured to evaluate the secondary magnetic flux and determine angle or rotational speed information from detected changes of the secondary magnetic flux.
